(19) United States
(12) Patent Application Publication
(10) Pub. No.: US 2021/0068482 A1
(43) Pub. Date: Mar. 11, 2021

(54) APPARATUS, SYSTEM, AND METHOD OF USING TEXTILE HAVING INTEGRAL SKIN ADHERING SUBSTRATE

(71) Applicant: Menicka Brown, Atlanta, GA (US)

(72) Inventor: Menicka Brown, Atlanta, GA (US)

(21) Appl. No.: 17/016,368

(22) Filed: Sep. 9, 2020

Related U.S. Application Data
(60) Provisional application No. 62/897,721, filed on Sep. 9, 2019.

(51) Int. Cl. A41D 31/04; A41D 23/00; A41F 9/00; A42B 7/00; A42B 1/04; G02C 5/12

(52) U.S. Cl. CPC A41D 31/04; A41D 23/00; A41F 9/002; A41B 11/12; A42B 1/041; G02C 5/12; A42B 7/00

(57) ABSTRACT

Disclosed herein are apparatuses and articles including an adhering portion comprising a textile having an integral surface adhering substrate, said adhering portion configured to releasably adhere to the surface using the integral surface adhering substrate. In one aspect, the adhering portion is configured to releasably adhere to a wearer's body surface and a garment body surface with friction, wherein the friction is sufficient to hold the apparatus and article in a fixed position without the need for adhesives or mechanical fasteners. Also disclosed herein method of using said textile having an integral skin adhering substrate and methods for making the disclosed apparatuses and articles.

### CROSS REFERENCE TO RELATED APPLICATIONS

The present application claims the benefit of priority to U.S. Provisional Patent Application Ser. No. 62/897,721, filed Sep. 9, 2019, which is hereby incorporated herein by reference in its entirety.

### FIELD OF DISCLOSURE

The present disclosure generally relates to a textile having integral skin adhering substrate for use as an adhering or fastening means, methods, systems, and articles using the same, for example, head coverings, consumer goods and garments.

### BACKGROUND OF THE DISCLOSURE

Many products and articles lack the ability to adhere to a surface or otherwise stay in place without the use of adhesives and mechanical fasteners. For example, head coverings such as scarves, head-wraps, and bonnets, which are often made of silk or satin, are worn on a person's head for aesthetic purpose or to protect hair. These head coverings may be even be worn overnight are often used to maintain hair styling, and may become displaced over the course of the evening or overnight. Thus, the conventional strategy is to use an elastic band or ties to keep the head covering in place. This often causes problems because the conventional strategy does not eliminate the common slipping off of the head covering overnight. Moreover, the use of traditional adhesives may be irritating to the skin or painful to remove. Likewise, mechanical fasteners may be uncomfortable to wear and can change the aesthetic look of the head covering due to their bulk.

Accordingly, there remains a need for improved adhering solutions that, when incorporated into products and articles can provide adequate adhesion to a surface, such as skin. Such adhering solutions would preferably be comfortable to wear in the case of garments, will not noticeably change the aesthetic look of an article and can potentially enhance the structure of an article. This need and other needs are satisfied by the various aspects of the present disclosure.

### BRIEF OVERVIEW

In accordance with the purposes of the invention, as embodied and broadly described herein, the invention, in one aspect, relates to apparatuses and articles comprising a textile having integral skin or surface adhering substrate. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In further aspects, the apparatus, article, system, and method involve the inventive use of a textile having an integral skin adhering substrate such as a leather substrate or synthetic leather substrate bonded to a textile layer substrate in a manner such that the combination is configured to create an adhering friction that prevents an apparatus or article attached thereto from changing position without intentional movement of the substrate combination.

In another aspect, the invention relates to an article comprising at least one adhering portion comprised of a textile having an integral surface adhering substrate, said adhering portion configured to releasably adhere to the surface using the adhering substrate, the adhering portion having an interior surface and an exterior surface corresponding to the adhering substrate. The adhering portion may comprise a first adhering portion configured to releasably adhere to a surface of an object of which an article is placed and/or to a surface of an article itself .

In another aspect, the invention relates to a garment configured to releasably adhere to a surface, such as a wearer's body surface or skin and/or the garment itself. The garment may generally comprise a garment body; and at least one garment adhering portion comprising textile having an integral skin adhering substrate, said garment adhering portion configured to releasably adhere to the surface using the adhering substrate, the garment adhering portion having an interior surface and an exterior surface corresponding to the adhering substrate. The garment adhering portion is configured to releasably adhere to a selected portion of wearer's body surface and/or a garment body surface, thus allowing the garment to stay in place without adhesives or mechanical fasteners.

In further aspects, the invention also relates methods for making and using the disclosed apparatuses and articles.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and/or sub-combinations described in the detailed description.

In one aspect, the apparatus, article, system, and method of using a textile having an integral skin adhering substrate may be an inventive use of a leather substrate or synthetic leather substrate bonded to a textile layer substrate in a manner such that the combination is configured to create an adhering friction that prevents the textile or fabric layer from changing position without intentional movement of the substrate combination.

In another aspect, the textile having an integral skin adhering substrate may comprise a second surface comprising at least one of: leather, plastic leather, vinyl, faux leather, vegan leather, and synthetic leather.

In yet another aspect, a textile having an integral skin adhering substrate may further comprise a second surface comprising at least one of: organic synthetic leather, from flax, cotton fibers, laminated palm oil, laminated corn oil, laminated soybean oil, and/or laminated plant oils to create a leather-like material, bi-cast leather, bonded leather, PVC faux leather fabric, and PU faux leather fabric; plastic, polyurethane, polyvinyl chloride (PVC), embossed paper; and/or combinations thereof.

In another aspect, embodiments using a textile having an integral skin adhering substrate may further comprise, a material comprising mixed fabric, piping, and/or cord. In still another aspect, embodiments using a textile having an integral skin adhering substrate further comprises the mixed fabric having one or more seams. In yet another aspect, embodiments using a textile having an integral skin adhering substrate further comprises the fabrics and substrates conjoined or bonded together forming a surface or substrate in combination with a textile or fabric configured such that the surface or substrate creates sufficient friction when applied to the epidermis layer of human skin such that it prevents involuntary movement of the textile from its intended position.

In another aspect, the apparatus, article, system, and method of using a textile having an integral skin adhering substrate practically may be used to adhere, grip, and/or position fabric to human skin. In another aspect, the apparatus, system, and method of using a textile having an integral skin adhering substrate is configured not to leave a bruise, impression, or indentation, and/or to not protrude upon in a bulky manner, and/or prod into or otherwise dig into the human skin while wearing and/or when it is removed. Furthermore, the apparatus, system, and method of using a textile having an integral skin adhering substrate may also be configured to not rupture the epidermis layer of the skin. Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIGS. 1A-1B show depictions of a textile having integral skin adhering substrate in accordance with an embodiment of the present disclosure.

FIGS. 2A-2B show depictions of eyeglasses comprising textile having integral skin adhering substrate in accordance with an embodiment of the present disclosure.

FIG. 3 shows a depiction of a textile having integral skin adhering substrate on a brimless cap in accordance with an embodiment of the present disclosure.

FIG. 4 shows a depiction of a textile having integral skin adhering substrate on a head covering in accordance with an embodiment of the present disclosure.

FIGS. 5A-5B show depictions of a belt comprising textile having integral skin adhering substrate in accordance with an embodiment of the present disclosure.

FIGS. 6A-6B show depictions of a scarf comprising textile having integral skin adhering substrate in accordance with an embodiment of the present disclosure.

FIG. 7 shows a depiction of a mat comprising textile having integral skin adhering substrate in accordance with an embodiment of the present disclosure.

FIG. 8 shows a depiction of a sock comprising textile having integral skin adhering substrate in accordance with an embodiment of the present disclosure.

FIG. 9 shows a depiction of an article of footwear comprising textile having integral skin adhering substrate in accordance with an embodiment of the present disclosure.

### DETAILED DESCRIPTION OF THE DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a textile having integral skin adhering substrate, embodiments of the present disclosure are not limited to use only in this context. The present disclosure can be understood more readily by reference to the following detailed description of the disclosure and the Examples included therein.

Before the present articles, systems, apparatus, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatus, systems, and articles of the disclosure as well as the apparatus themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatus of the disclosure. Thus, if there are a variety of additional steps that can be performed it is understood that each of these additional steps can be performed with any specific aspect or combination of aspects of the methods of the disclosure.

It is understood that the apparatus and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### I. Brief Overview

Consistent with embodiments of the present disclosure, a textile having integral skin adhering substrate, apparatuses objects, and articles comprising said textile, and methods for using said textile to add adhesive properties to articles, objects and garments may be provided. This overview is provided to introduce a selection of concepts in a simplified form that are further described below. This overview is not intended to identify key features or essential features of the claimed subject matter. Nor is this overview intended to be used to limit the claimed subject matter's scope. The textile having integral skin adhering substrate may be used by individuals or companies to manufacture various articles such as clothing, garments, footwear, body jewelry, improved head gear, head wraps, hair bonnets, hair wraps, scarf positioning fabric accessories, belts, mats, skin adhering shoe insoles, among other innovative uses.

In one or more aspects, the apparatus, article, system, and method of using a textile having an integral skin adhering substrate further comprises the mixed fabric having one or more seams. In some aspects, the textile may be seamless. In another aspect, the apparatus, article, system, and method of using a textile having an integral skin adhering substrate further comprises the fabrics and substrates conjoined or bonded together forming a surface or substrate in combination with a textile or fabric configured such that the surface or substrate creates sufficient friction when applied to the epidermis layer of human skin such that it prevents involuntary movement of the textile from its intended position.

In another aspect, the apparatus, article, system, and method of using a textile having an integral skin adhering substrate practically may be used to adhere, grip, or position fabric to human skin. In another aspect, the apparatus, article, system, and method of using a textile having an integral skin adhering substrate is configured not to leave a bruise, impression, or indentation on the human skin when worn or removed. Furthermore, the apparatus, article, system, and method of using a textile having an integral skin adhering substrate may also be configured to not rupture or otherwise protrude upon or into the epidermis layer of the skin, such as to puncture the skin.

The textile having an integral skin adhering substrate may be a piece of fabric, silk, satin, or other fabrics that slip easily upon the skin. The skin adhering substrate may be placed atop the skin maintaining a barrier between the skin and the textile of choice. In at least one instance, a silk or satin textile hair garment may be positioned across a user's forehead and secured in place by the skin adhering substrate such that the position is maintained regardless of movement (i.e. movement of a head across a pillow or bed during sleep) and the textile hair garment does not fall off.

An intended use for the textile having an integral skin adhering substrate may be for articles and garments such as silk and satin scarfs, head-wrap scarfs, caps, du-rags, or other head gear material suitable to protect hair for daytime, showering and/or overnight uses. The textile having an integral skin adhering substrate may allow the head covering to stay in place on the head overnight. This solves the problem of head-wrap and protective wear bonnets that may fall off of a user's head in the middle of the night throughout sleep. Other advantages may include the ability of the integral skin adhering substrate to maintain effective use without having performance diminished or adversely affected by sweat or water. Additionally, the textile having an integral skin adhering substrate does not have to be tied excessively tight in order to stay in place. Furthermore, the textile having an integral skin adhering substrate does not leave a line, indentation, bruise, scar, or impression upon the forehead of its user. The textile having an integral skin adhering substrate may be configured such that it lays gently on the skin in-between a garment and a user's skin without leaving a residue or imprint.

Another use for the textile having an integral skin adhering substrate may be to keep scarfs in a fixed position when draped. For example, preventing a fabric from turning too easily when placed about the neckline. Additionally, the textile having an integral skin adhering substrate may have many possible uses and functions as a non-slip/gripping skin adhering material.

In further instances, the textile having an integral skin adhering substrate may be used by anyone wanting to use it to keep their neck or head scarves, stockings, leggings, shirts or other various garments or hats in place. In other instances, textile having an integral skin adhering substrate may be used by anyone desiring to have a fabric semi-adhered to the skin. Examples may include but not be limited to anyone looking to cover or protect their hair at night or cover it during the daytime whether for function or fashion. In even further instances, the textile having an integral skin adhering substrate may be used for anyone wanting to allow an improved grip, more effective grip, tighter grip between the skin and another object. Examples may include but not be limited to a hand grip for golf clubs, handle bars, weight lifting bars, pull-up bars, exercise equipment, large furniture grips, equipment grips, machine grips, gripping gloves, etc.

In various aspects, an article or garment of the present invention may be configured to releasably adhere to a surface, such as skin or a surface of the object the article is placed on. An article may comprise at least one adhering portion comprising a textile having an integral surface adhering substrate, said adhering portion configured to releasably adhere to the surface using the adhering substrate, the adhering portion having an interior surface and an exterior surface corresponding to the adhering substrate. The adhering portion may comprise a first adhering portion configured to releasably adhere to a surface of an object the article is placed on. In some aspects, the adhering portion may comprise a first adhering portion configured to releasably adhere to a surface of the article. In other aspects, the adhering portion may comprise a first adhering portion configured to releasably adhere to a surface of the article, and a second adhering portion configured to releasably adhere a surface the article is placed or disposed on.

The article can be any desired article that needs to be positioned and remain in place, and may generally be at least one of: an article of clothing, such as a garment, an article of eyewear, an article of footwear, or article of manufacture, or combinations thereof.

In further aspects, a garment of the present invention is configured to releasably adhere to a surface, such as skin or the garment body itself. A garment may comprise a garment body and at least one garment adhering portion comprising textile having an integral skin adhering substrate, said garment adhering portion configured to releasably adhere to the surface using the adhering substrate, the garment adhering portion having an interior surface and an exterior surface corresponding to the adhering substrate. The garment adhering portion may be configured to releasably adhere to a wearer's body surface and a garment body surface. In further aspects, an adhering portion comprises a first adhering portion configured to releasably adhere to a wearer's skin, and a second adhering portion configured to releasably adhere to a second portion of the wearer's skin. In still further aspects, the at least one adhering portion comprises a first adhering portion configured to releasably adhere to a wearer's skin, and a second adhering portion configured to releasably adhere to the garment body. In yet further aspects, the adhering portion comprises at least one adhering panel or adhering strip comprised of the textile having the integral skin adhering substrate.

In further aspects, the garment adhering portion may comprise a plurality of adhering panels or adhering strips, for example, a first adhering panel configured to releasably adhere to a first portion of wearer's skin and a second adhering panel configured to releasably adhere to a second portion of the wearer's skin. In still further aspects, a first adhering panel may be configured to releasably adhere to a portion of wearer's skin and a second adhering panel may be configured to releasably adhere to a surface of the garment body. In yet further aspects, at least one adhering panel of the plurality of adhering panels comprises a top adhering panel configured to releasably adhere to a second portion of the wearer's skin. In even further aspects, at least one adhering panel of the plurality of adhering panels comprises a bottom adhering panel configured to releasably adhere around a third portion of the wearer's body. In still further aspects, at least one adhering panel of the plurality of adhering panels comprises a middle adhering panel configured to releasably adhere around or to a fourth portion of the wearer's body. In yet further aspects, at least one adhering panel of the plurality of adhering panels comprises a middle adhering panel configured to releasably adhere around or to a fifth portion of the wearer's body.

In further aspects, an adhering panel may be configured to releasably adhere around a portion of the wearer's waist, around a portion of the wearer's ankle, to a portion of the wearer's forehead, around a portion of the wearer's wrist, around a portion of the wearer's thigh, or other body parts.

In various aspects, the adhering panel may be connected or attached to a garment body or body of an article. In further aspects, a first edge of at least one adhering panel and a second edge of a top adhering panel are connected or attached. In some aspects, one adhering panel may be connected or attached to at least one other adhering panel. In other aspects, a first edge of at least one adhering panel and a second edge of a top adhering panel are connected or attached. In still further aspects, a first end, a second end, and/or middle portion of the garment body are attached or connected to different adhering panels. A first edge or end of the garment is attached or connected to at least one adhering panel. Still further, a first edge or end of the garment may be attached or connected to at least one adhering panel, and a second opposed end of the garment body is attached or connected to at least one other adhering panel.

In further aspects, at least one adhering panel may be circumferentially disposed on a garment body surface, such as circumferentially disposed on an interior garment body surface. In still further aspects, at least one adhering panel may be circumferentially disposed on an interior top edge of the garment body. In some aspects, at least one adhering panel is circumferentially disposed on a top portion and middle portion.

In further aspects, an adhering panel may comprise at least one of an outer panel having an interior surface and exterior surface, or an inner panel having an interior surface and exterior surface. In still further aspects, the adhering panel may comprise an outer panel having an interior surface and exterior surface and an inner panel having an interior surface and exterior surface. Still further, an adhering panel may comprise at least one of an outer layer having an interior surface and exterior surface, or an inner layer having an interior surface and exterior surface. Yet further, an adhering panel may comprise an outer layer having an interior surface and exterior surface and an inner layer having an interior surface and exterior surface. In some aspects, a portion of the article or garment body may be disposed between an outer panel and inner panel of at least one adhering panel. In other aspects, a portion of the article or garment body may be disposed between an outer panel and inner panel of a plurality of adhering panels. In still further aspects, a portion of the article or garment body may be between an outer layer and inner layer of at least one adhering panel. In yet further aspects, a portion of the article or garment body is disposed between an outer layer and inner layer of a plurality of adhering panels. The adhering panel is comprised of a non-slip material configured to be releasably adhered against a portion of a wearer's body. The adhering panel may be comprised of a material configured to releasably adhere an opening of the garment body against a portion of a wearer's body.

In further aspects, an adhering panel may define an outermost opening and/or edge of the article or garment body, such as, wherein a top adhering panel defines an outermost opening and/or edge of the article or garment body, or a bottom adhering panel defines an outermost opening and/or edge of the article or garment body, or wherein the top adhering panel defines a first outermost opening and/or edge of the article or garment body, and wherein a bottom adhering panel defines an opposed, second outermost opening and/or edge of the article or garment body. The adhering panel may comprise an outer panel and inner panel which may be integrated and/or comprise two-ply construction. An outer panel and inner panel may be integrated and/or comprise a two-ply construction in the portions where they attached or overlap, and/or an outer layer and inner layer may be integrated and/or comprise a two-ply construction.

In various aspects, the garment or article may further comprise at least one attachment means configured to attach one or more garment portions or adhering panels, which may be disposed on one more portions of an inner surface of at least one adhering panel, and/or disposed on one more ends of at least one adhering panel.

In some aspects, at least one adhering panel may comprise a plurality of attachment means configured to detachably connect to one or more adhering panels; and wherein the plurality of attachment means comprise a plurality of attachment positions configured to allow for adjustment of skin adhering positioning. In such embodiments, the attachment means may comprise at least one of hook and loop fasteners, buttons, hooks, snaps, fasteners, or a combination thereof.

In further aspects, a gripping area may be on the adhering substrate.

The gripping area may comprise a portion or all of the exterior surface of the adhering panel. The anti-slip material may encompass a portion or all of a surface of the gripping area. The anti-slip material may include, thermoplastic elastomers (TPEs), high-friction rubber, vinyl, or the like materials as disclosed herein.

In various aspects, the garment is configured to remain in place without the use of adhesives or mechanical fasteners, and configured to hold on a user's skin. The adhering panel may comprise a non-breathable material, and add structure to the portion of the garment body. In further aspects, the adhering panel may form a waterproof barrier or seal when adhered to the skin or attached surface. Thus, such embodiments of garments comprising an adhering panel can be worn in the shower to prevent hair from getting wet.

In some aspects, the garment body comprises at least one of silk, satin, cotton, latex, LYCRA, silicone, spandex, nylon, elastane, polyester, lace, or a combination thereof. In other aspects, the garment body may comprise at least one of a woven fabric, non-woven fabric, natural fabric, synthetic fabric, or combinations thereof. The garment or article the article of clothing may be selected from a cap, scarf, head covering, sock, legging, legging, sleeve, and belt, or the like.

In further aspects, one or more elements or components can be detachably connected to the articles, objects or garments, e.g., to allow interchange and/or replacement of one or more elements such as adhesion panel or strips. Such configurations allow users, purchasers, retailers, or others to select desired materials and adhesion properties or levels, e.g., for customization purposes, for personal preferences, to match desired use, a user's physical characteristics, surface or skin properties, or to repair or replace defective or damaged adhesion panels, etc.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Apparatus Configuration

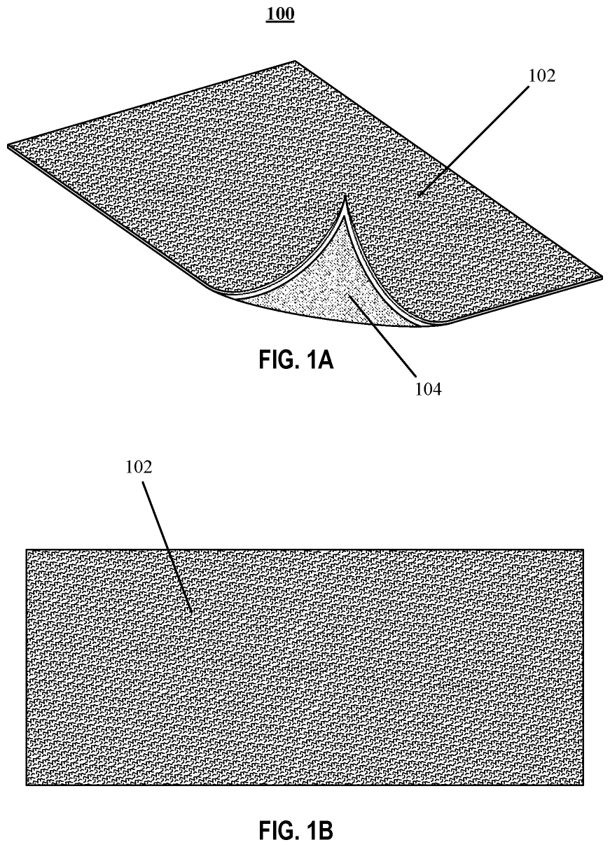

According to various aspects of the invention, embodiments of the present disclosure can comprise multiple configurations. For example, various illustrative embodiments of the invention are shown in FIGS. 1A-9.

In various further aspects, an apparatus, article, and/or garment of the present invention may comprise a textile having an integral skin adhering substrate. The textile having an integral skin adhering substrate may comprise one or more of: bi-cast leather, bonded leather, PVC faux leather fabric, PU faux leather fabric, leather, plastic leather, vinyl, faux leather, pleather, vegan leather, and synthetic leather. In one or more instances, the integral skin adhering substrate may comprise organic synthetic leather made from flax, cotton fibers laminated using palm, corn, soybean or other plant oils to create a leather-like material.

In further aspects, integral skin adhering substrate may comprise various grades of leather made from traditional old and well-known leather tanning methods. Leather tanning methods as well as methods of creating synthetic leather are known and are hereby incorporated herein.

As briefly described above, the present disclosure relates, in various aspects, to a textile having an integral skin adhering substrate, and articles and garments comprising said textile. In one aspect, the present disclosure provides a textile fabric. In further aspects, the textile is integrally bonded to a skin adhering substrate. In still further aspects, the bonding of the skin adhering substrate to the textile may be performed using one or more fastening, adhering, adhesive, and bonding materials. This includes but is not limited to sewing, attachments, adhering using fabric glue, and the like. In even further aspects, the bonding of the skin adhering substrate to the textile may be performed using one or more bonding processes, systems, and methods.

In one or more instances, a textile substrate may be bonded directly to the skin adhering substrate without any padding or backing. In another instance, the textile substrate may be bonded to the skin adhering substrate in a manner which includes padding or backing.

FIGS. 1A-1B show depictions of a textile 100 having integral skin adhering substrate 102 in accordance with an embodiment of the present disclosure. FIG. 1A shows a view of the textile 100 depicting both the integral skin adhering substrate 102 (i.e., exterior surface) and a backing 104 or base of the textile (interior surface), and FIG. 1B shows a top view of the integral skin adhering substrate 102. The interior surface 104 may be bonded to another material in a manner such that the combination can be incorporated into an article or garment configured to create an adhering friction exterior surface that prevents the article or garment to which it is bonded from sliding or changing position without intentional movement of the adhering substrate, for example by a user or wearer. As described herein, the textile 100 can be cut into adhesion strips or panels to correspond to the size and location where adhesion is needed.

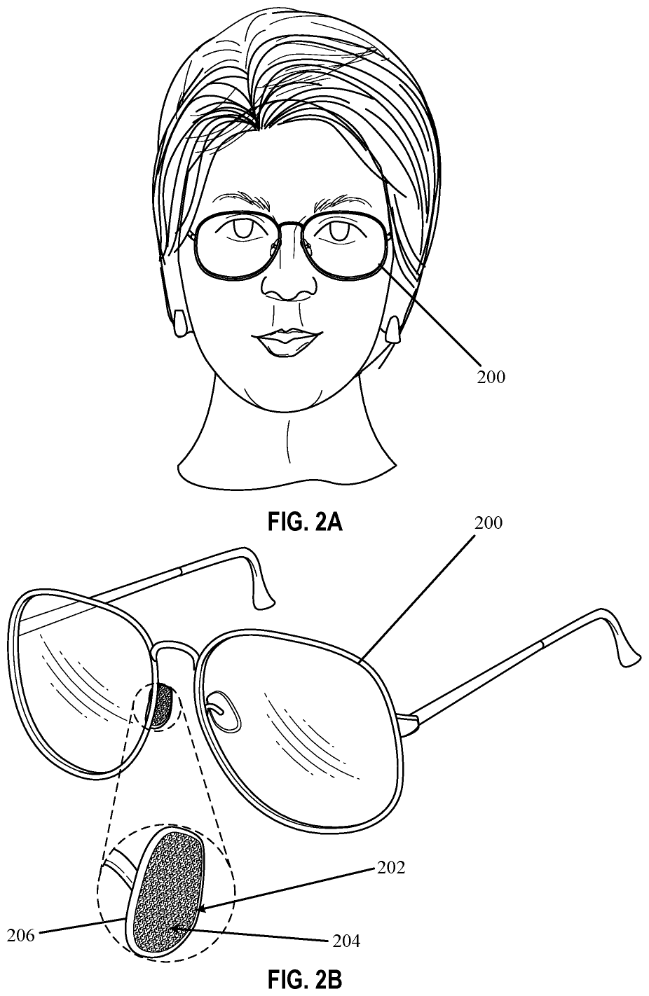

FIGS. 2A-2B show a depiction of eyeglasses 200 comprising adhesion panel 202 comprised of a textile having integral skin adhering substrate 204 on the temple pads 206 of the eyeglasses in accordance with an embodiment of the present disclosure. FIG. 2B shows a closer aspect of the temple pads 206 where the adhesion panel 202 having integral skin adhering substrate 204 has been installed, which correspond to the portion of the temple pads 206 that rests upon the user's nose as shown in FIG. 2A. The textile can be bonded to the temple pad surface. Bonding may include fabric glue, silicone, heated glue from a glue gun, and/or other well-known adhesion and bonding methods.

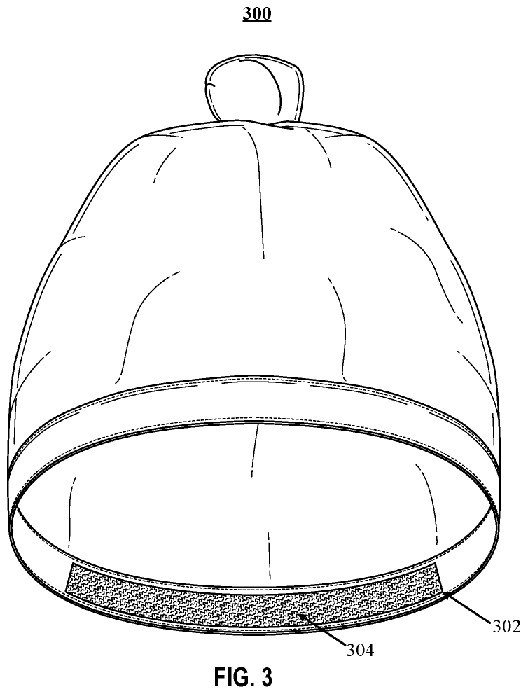

FIG. 3 shows a depiction of a cap 300 including an adhesion panel 302 comprised of textile having integral skin adhering substrate 304 in accordance with an embodiment of the present disclosure. As shown, the adhesion panel 302 is circumferentially installed on the inside edge of the cap 300, with the integral skin adhering substrate 304 exposed for adhering to the user's forehead. While only one adhesion panel is shown, there may embodiments comprising multiple adhesion panels. The adhesion panel 302 may bonded to the garment body in a manner such that the combination is configured to create an adhering friction that prevents the garment body from changing position without intentional movement of the substrate combination.

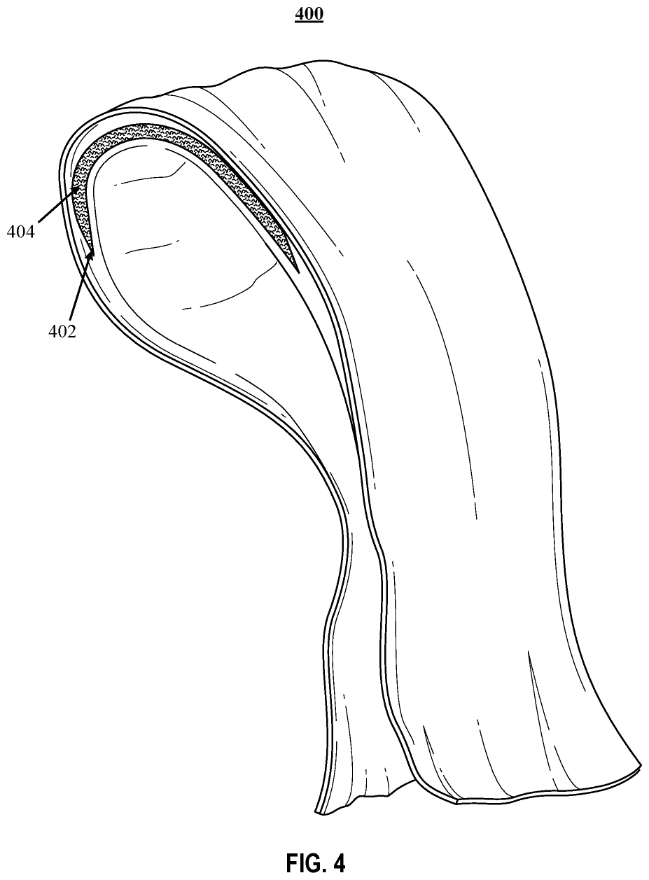

FIG. 4 shows a depiction of a head covering 400 including an adhesion strip 402 comprised of textile having integral skin adhering substrate 404 in accordance with an embodiment of the present disclosure. As shown, the adhesion panel 402 is installed on a middle edge of the head covering 400 corresponding to the forehead, with the integral skin adhering substrate 402 exposed for adhering to the user's forehead. While only one adhesion strip is shown, there may embodiments comprising multiple adhesion strips or panels as shown described herein. The adhesion panel may be positioned on the garment body in a manner such that the combination is configured to create an adhering friction that prevents the garment body from changing position on the forehead without intentional movement of the substrate combination.

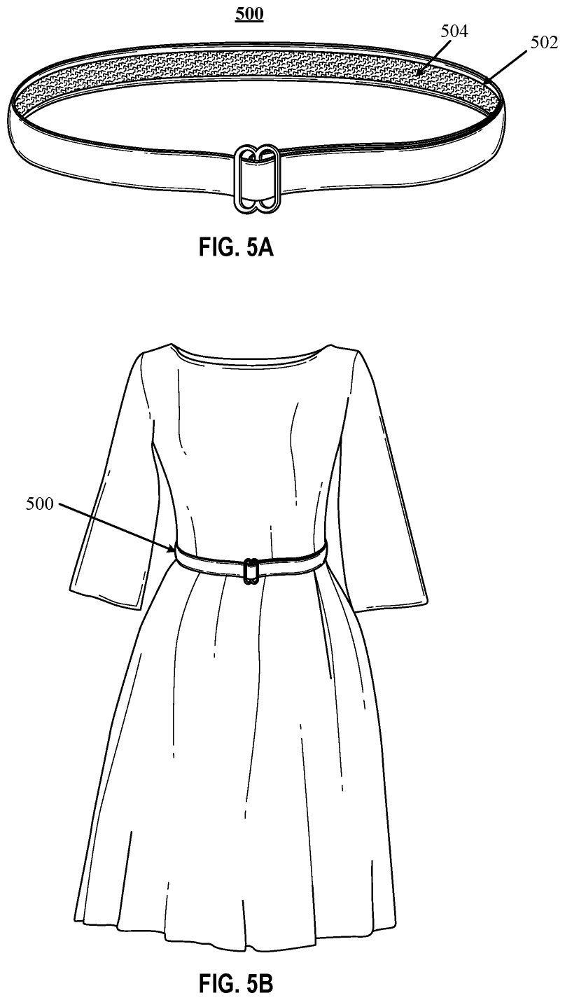

FIGS. 5A-5B show depictions of a belt 500 comprising an adhesion panel 502 comprised of textile having integral surface adhering substrate 504 in accordance with an embodiment of the present disclosure. FIG. 5A shows the outer and inner surfaces of the belt 500, wherein the adhesion panel 502 is circumferentially installed on the entire inner surface of the belt, with the integral surface adhering substrate 504 exposed to allow the inner surface of belt to adhering to the outer surface of the belt, thus preventing the garment body from moving until removed by the user.

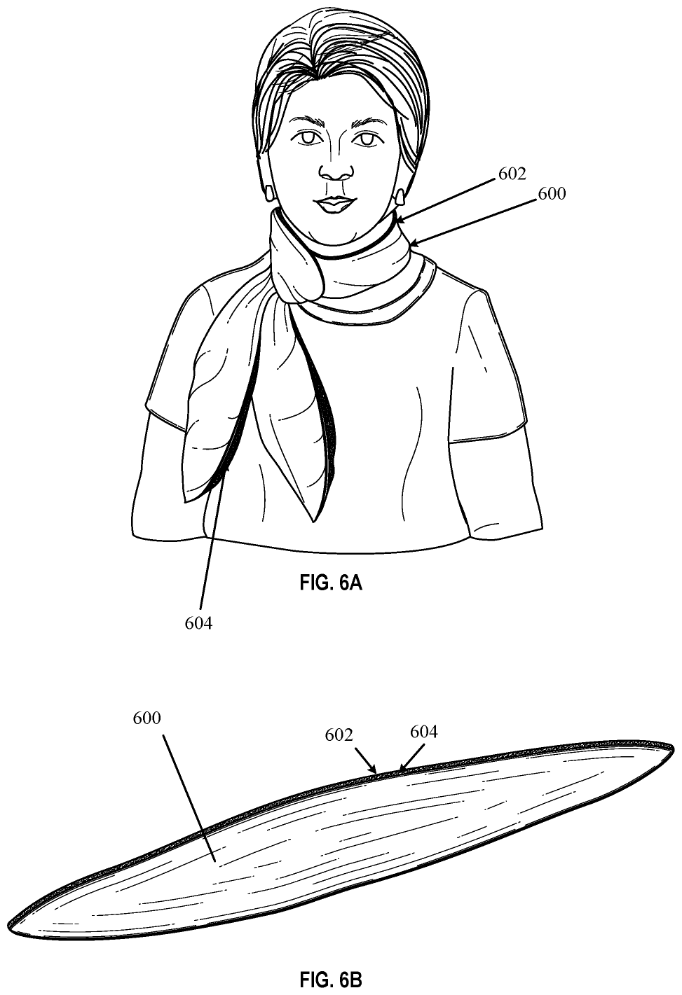

FIGS. 6A-6B show depictions of a scarf 600 comprising an adhesion strip 602 comprised of textile having integral surface adhering substrate 604 in accordance with an embodiment of the present disclosure. FIG. 6B shows the outer and inner surfaces of the scarf 600, wherein the adhesion strip 602 is circumferentially installed on the entire inner edge of the scarf 600. As showing in FIG. 6A, installing the adhesion strip 602 along the entire inner edge of the scarf 600 allows the exposed integral surface adhering substrate 604 to adhere to both the skin of the user at the surface of the scarf, thus allowing the scarf to be worn in multiple configurations without the use of a mechanical fastener or clips, while preventing the scarf fabric from turning easily when placed about the neckline of the user.

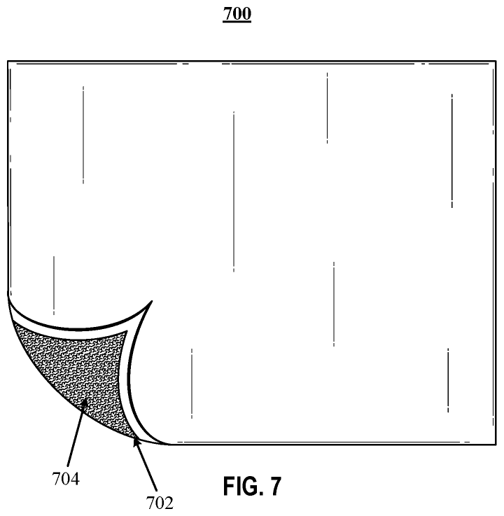

FIG. 7 shows a depiction of mat 700 comprised of a textile having integral skin adhering substrate 704 in accordance with an embodiment of the present disclosure. FIG. 7 shows textile is in the form of a large adhesion panel 702 bonded to the back of the mat 700, which correspond to the portion of the mat that rests upon a table or object surface. The exposed integral surface adhering substrate 704 allows the mat 700 to adhere surface while preventing the mat from moving while in use. FIG. 7 shows a more rigid or fixed textile fabric.

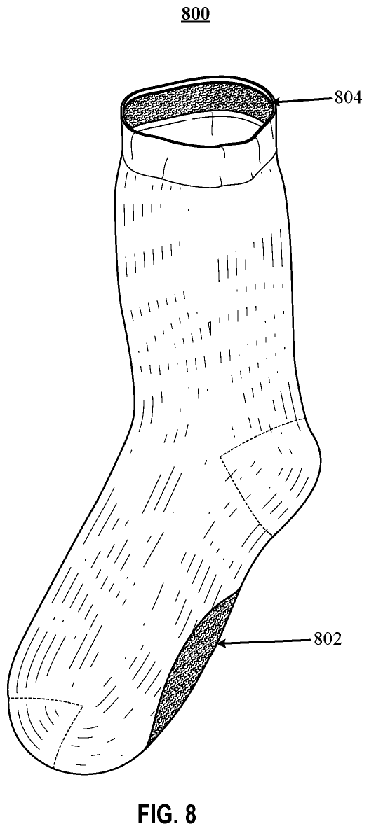

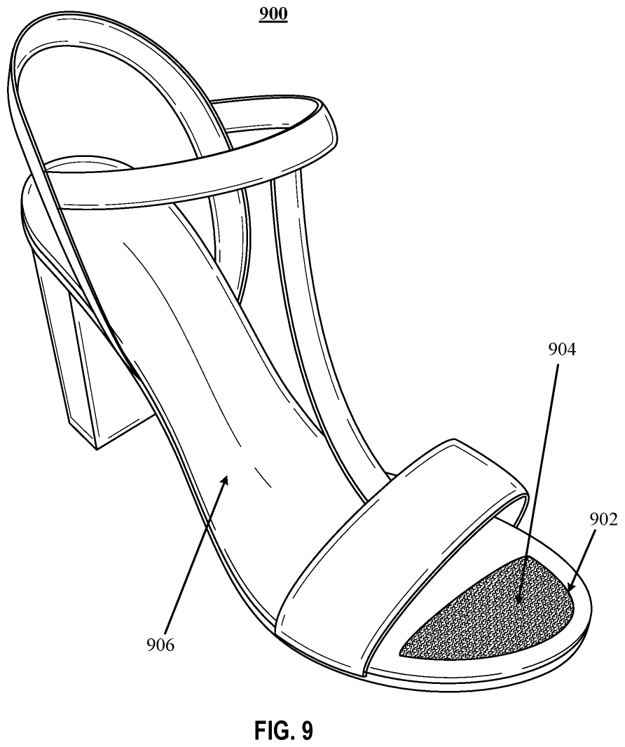

FIG. 8 show a depiction of a sock 800 comprising one adhesion panel 802 and one adhesion strip 804, each comprised of a textile having integral skin or surface adhering substrate in accordance with an embodiment of the present disclosure. As shown, the adhesion panel 802 is installed on the outer surface of sock in the area corresponding to the portion of the user's foot that contact the ground or insole of footwear. The adhesion strip 804 is circumferentially installed on the entire inner top edge of the sock, corresponding to the leg, with the integral skin adhering substrate exposed for adhering to the user's skin. While shown as a sock, the skin or surface adhering portions may be integrated or attached to a stocking, pantyhose, or other foot garment. Such may be used in conjunction with any article of footwear or with an article of footwear comprising an adhesion panel, such as shown in FIG. 9.

FIG. 9 show a depiction of an article of footwear 900 comprising an adhesion panel 902 comprised of a textile having integral skin adhering substrate 904 on the insole 906 in accordance with an embodiment of the present disclosure. The adhesion panel 902 is installed in the area corresponding to the portion of the insole 906 where the user's toes are placed. While only one adhesion panel is shown, there may embodiments comprising multiple adhesion panels may be installed, such as on the heel area and/or midfoot/arch area, or area of the insole where adhesion and grip between the user's foot and insole are needed. For instance, in the shown high heel shoe, the adhering panel on the insole may allow a user's foot not to slip while walking in the shoe barefoot or in a stocking, pantyhose, socks, or another textile. In some aspects, the adhesion panel may be attached to a removable insert configured to be removably secured to footwear. The insert may be a full or partial insole and can be moved between different articles of footwear.

### III. Methods for Using the Apparatus and Article

The present disclosure, according to further aspects, also provides methods of using the disclosed apparatuses, articles and systems. In one aspect, disclosed herein is a method for using or positioning article comprising a textile having integral skin adhering substrate on a wearer as a garment.

In another aspect, a method for releasably adhering a garment to a skin of a wearer may be disclosed, the method comprising the steps of providing any disclosed garment or article; and using the adhering substrate of the adhering portion to releasably adhere the garment to the wearer's skin or the article to an object. In further aspects, the step of using may comprise at least one of: wearing the garment, securing at least one adhering panel against a portion of the wearer's body, pulling an opening of the garment up on the wearer, securing at least one opening around a portion of the wearer's body, and placing the adhering portion around the wearer's such that the garment does not move.

The invention includes at least the following aspects: Aspect 1: An article configured to releasably adhere to a surface, the article comprising: an article; and at least one adhering portion comprising a textile having an integral surface adhering substrate, said adhering portion configured to releasably adhere to the surface using the adhering substrate, the adhering portion having an interior surface and an exterior surface corresponding to the adhering substrate.

Aspect 2: The article of any preceding aspect, wherein the at least one adhering portion comprises a first adhering portion configured to releasably adhere to a surface of an object the article is placed on.

Aspect 3: The article of any preceding aspect, wherein the at least one adhering portion comprises a first adhering portion configured to releasably adhere to a surface of the article.

Aspect 4: The article of any preceding aspect, wherein the at least one adhering portion comprises a first adhering portion configured to releasably adhere to a surface of the article, and a second adhering portion configured to releasably adhere a surface the article is placed or disposed on.

Aspect 5: The article of any preceding claim, wherein the article is at least one of: an article of clothing, an article of eyewear, and article of footwear, or article of manufacture, or combinations thereof.

Aspect 6: A garment configured to releasably adhere to a surface, the garment comprising:

a garment body; and at least one garment adhering portion comprising textile having an integral skin adhering substrate, said garment adhering portion configured to releasably adhere to the surface using the adhering substrate, the garment adhering portion having an interior surface and an exterior surface corresponding to the adhering substrate, a first edge and a second edge; wherein the garment adhering portion is configured to releasably adhere to a wearer's body surface and a garment body surface.

Aspect 7: The garment or article of any preceding aspect, wherein the at least one adhering portion comprises a first adhering portion configured to releasably adhere to a wearer's skin, and a second adhering portion configured to releasably adhere to a second portion of the wearer's skin.

Aspect 8: The garment or article of any preceding aspect, wherein the at least one adhering portion comprises a first adhering portion configured to releasably adhere to a wearer's skin, and a second adhering portion configured to releasably adhere to the garment body.

Aspect 9: The garment or article of any preceding aspect, wherein the adhering portion comprises at least one adhering panel or adhering strip comprised of the textile having the integral skin adhering substrate.

Aspect 10: The garment or article of any preceding aspect, wherein the garment adhering portion comprises a plurality of adhering panels or adhering strips.

Aspect 11: The garment or article of any preceding aspect, comprising a first adhering panel configured to releasably adhere to a first portion of wearer's skin and a second adhering panel configured to releasably adhere to a second portion of the wearer's skin.

Aspect 12: The garment or article of any preceding aspect, comprising a first adhering panel configured to releasably adhere to a portion of wearer's skin and a second adhering panel configured to releasably adhere to a surface of the garment body.

Aspect 13: The garment or article of any preceding aspect, wherein at least one adhering panel of the plurality of adhering panels comprises a top adhering panel configured to releasably adhere to a second portion of the wearer's skin.

Aspect 14: The garment or article of any preceding aspect, wherein at least one adhering panel of the plurality of adhering panels comprises a bottom adhering panel configured to releasably adhere around a third portion of the wearer's body.

Aspect 15: The garment or article of any preceding aspect, wherein at least one adhering panel of the plurality of adhering panels comprises a middle adhering panel configured to releasably adhere around a fourth portion of the wearer's body.

Aspect 16: The garment or article of any preceding aspect, wherein at least one adhering panel of the plurality of adhering panels comprises a middle adhering panel configured to releasably adhere around a fifth portion of the wearer's body.

Aspect 17: The garment or article of any preceding aspect, comprising an adhering panel configured to releasably adhere around a portion of the wearer's waist.

Aspect 18: The garment or article of any preceding aspect, comprising an adhering panel configured to releasably adhere around a portion of the wearer's ankle.

Aspect 19: The garment or article of any preceding aspect, comprising an adhering panel configured to releasably adhere to a portion of the wearer's forehead.

Aspect 20: The garment or article of any preceding aspect, comprising an adhering panel configured to releasably adhere around a portion of the wearer's wrist.

Aspect 21: The garment or article of any preceding aspect, wherein at least one adhering panel of the plurality of adhering panels comprises a bottom adhering panel configured to releasably adhere around a first portion of the wearer's thigh.

Aspect 22: The garment or article of any preceding aspect, wherein at least one adhering panel is connected or attached to a garment body or body of an article.

Aspect 23: The garment or article of any preceding aspect, wherein a first edge of at least one adhering panel and a second edge of a top adhering panel are connected or attached.

Aspect 24: The garment or article of any preceding aspect, wherein one adhering panel is connected or attached to at least one other adhering panel.

Aspect 25: The garment or article of any preceding aspect, wherein a first edge of at least one adhering panel and a second edge of a top adhering panel are connected or attached.

Aspect 26: The garment or article of any preceding aspect, wherein a first end, a second end, and/or middle portion of the garment body are attached or connected to different adhering panels.

Aspect 27: The garment of any preceding aspect, wherein a first edge or end of the garment is attached or connected to at least one adhering panel.

Aspect 28: The garment or article of any preceding aspect, wherein a first edge or end of the garment is attached or connected to at least one adhering panel, and a second opposed end of the garment body is attached or connected to at least one other adhering panel.

Aspect 29: The garment or article of any preceding aspect, wherein a first end of the band is attached or connected to a first adhering panel, a second opposed end of the band is attached or connected to a second adhering panel, and middle portion of the band is attached or connected to a third adhering panel.

Aspect 30: The garment or article of any preceding aspect, wherein the at least one adhering panel is circumferentially disposed on a garment body surface.

Aspect 31: The garment or article of any preceding aspect, wherein the at least one adhering panel is circumferentially disposed on an interior garment body surface.

Aspect 32: The garment or article of any preceding aspect, wherein the at least one adhering panel is circumferentially disposed on an interior top edge of the garment body.

Aspect 33: The garment or article of any preceding aspect, wherein the at least one adhering panel is circumferentially disposed on a top adhering panel and an upper middle adhering panel.

Aspect 34: The garment or article of any preceding aspect, wherein at least one adhering panel of the plurality of adhering panels comprises at least one of an outer panel having an interior surface and exterior surface, or an inner panel having an interior surface and exterior surface.

Aspect 35: The garment or article of any preceding aspect, wherein at least one adhering panel of the plurality of adhering panels comprises an outer panel having an interior surface and exterior surface and an inner panel having an interior surface and exterior surface.

Aspect 36: The garment or article of any preceding aspect, wherein at least one adhering panel of the plurality of adhering panels comprises at least one of an outer layer having an interior surface and exterior surface, or an inner layer having an interior surface and exterior surface.

Aspect 37: The garment or article of any preceding aspect, wherein at least one adhering panel of the plurality of adhering panels comprises an outer layer having an interior surface and exterior surface and an inner layer having an interior surface and exterior surface.

Aspect 38: The garment or article of any preceding aspect, wherein a portion of the article or garment body is disposed between an outer panel and inner panel of at least one adhering panel.

Aspect 39: The garment or article of any preceding aspect, wherein a portion of the article or garment body is disposed between an outer panel and inner panel of a plurality of adhering panels.

Aspect 40: The garment or article of any preceding aspect, wherein a portion of the article or garment body between an outer layer and inner layer of at least one adhering panel.

Aspect 41: The garment or article of any preceding aspect, wherein a portion of the article or garment body is disposed between an outer layer and inner layer of a plurality of adhering panels.

Aspect 42: The garment or article of any preceding aspect, wherein the adhering panel is comprised of a non-slip material configured to be releasably adhered against a portion of a wearer's body.

Aspect 43: The garment of any preceding aspect, wherein the adhering panel is comprised of a material configured to releasably adhere an opening of the garment body against a portion of a wearer's body.

Aspect 44: The garment or article of any preceding aspect, wherein at least one adhering panel defines an outermost opening and/or edge of the article or garment body.

Aspect 45: The garment or article of any preceding aspect, wherein a top adhering panel defines an outermost opening and/or edge of the article or garment body.

Aspect 46: The garment or article of any preceding aspect, wherein a bottom adhering panel defines an outermost opening and/or edge of the article or garment body.

Aspect 47: The garment or article of any preceding aspect, wherein the top adhering panel defines a first outermost opening and/or edge of the article or garment body, and wherein a bottom adhering panel defines an opposed, second outermost opening and/or edge of the article or garment body.

Aspect 48: The garment or article of any preceding aspect, wherein an adhering panel may comprise an outer panel and inner panel which may be integrated and/or comprise two-ply construction.

Aspect 49: The garment or article of any preceding aspect, wherein an outer panel and inner panel may be integrated and/or comprise a two-ply construction in the portions where they attached or overlap.

Aspect 50: The garment or article of any preceding aspect, wherein an outer layer and inner layer may be integrated and/or comprise a two-ply construction.

Aspect 51: The garment or article of any preceding aspect, further comprising at least one attachment means configured to attach one or more garment portions or adhering panels.

Aspect 52: The garment or article of any preceding aspect, wherein an attachment means is disposed on one more portions of an inner surface of at least one adhering panel.

Aspect 53: The garment or article of any preceding aspect, wherein an attachment means is disposed on one more ends of at least one adhering panel.

Aspect 54: The garment or article of any preceding aspect, wherein at least one adhering panel comprises a plurality of attachment means configured to detachably connect to one or more adhering panels using one or more bands; and wherein the plurality of attachment means comprise a plurality of attachment positions configured to allow for adjustment of skin adhering positioning.

Aspect 55: The garment or article of any preceding aspect, wherein the attachment means comprises at least one of hook and loop fasteners, buttons, hooks, snaps, fasteners, or a combination thereof.

Aspect 56: The garment or article of any preceding aspect, further comprising a gripping area on the adhering substrate.

Aspect 57: The garment or article of any preceding aspect, wherein the gripping area comprises a portion or all of the exterior surface of the adhering panel.

Aspect 58: The garment or article of any preceding aspect, wherein the anti-slip material is disposed on a portion or all of a surface of the gripping area.

Aspect 59: The garment or article of any preceding aspect, wherein the anti-slip material comprises at least one of thermoplastic elastomers (TPEs), high-friction rubber, vinyl, or the like.

Aspect 60: The garment or article of any preceding aspect, wherein the garment is configured to remain in place without the use of adhesives or mechanical fasteners.

Aspect 61: The garment or article of any preceding aspect, wherein the garment is constructed as a one-piece undergarment and configured to hold on a user's skin.

Aspect 62: The garment or article of any preceding aspect, wherein the adhering panel comprises a non-breathable material.

Aspect 63: The garment of any preceding aspect, wherein the garment body comprises at least one of silk, satin, cotton, latex, LYCRA, silicone, spandex, nylon, elastane, polyester, lace, or a combination thereof.

Aspect 64: The garment of any preceding aspect, wherein the garment body comprises at least one of a woven fabric, non-woven fabric, natural fabric, synthetic fabric, or combinations thereof.

Aspect 65: The garment of any preceding aspect, wherein the garment is configured to fit men and women.

Aspect 66: The garment of any preceding aspect, wherein the garment is unisex.

Aspect 67: The garment of any preceding aspect, further comprising an outer garment body configured to connect to the adhering portion.

Aspect 68: The garment or article of any preceding aspect, wherein an inner surface of the outer garment body is configured to connect to an inner surface of the adhering portion.

Aspect 69: The garment or article of any preceding aspect, wherein the outer garment body comprises an article of clothing.

Aspect 70: The garment or article of any preceding aspect, wherein the article of clothing selected from a cap, scarf, head covering, sock, legging, legging, sleeve, and belt.

Aspect 71: A method for releasably adhering a garment to a skin of a wearer, the method comprising the steps of: a) providing the garment of any preceding aspect; and b) using the adhering substrate of the adhering portion to releasably adhere the garment to the wearer's skin.

Aspect 72: The method of any preceding aspect, wherein the step of using comprises at least one of: wearing the garment, securing at least one adhering panel against a portion of the wearer's body, pulling an opening of the garment up on the wearer, securing at least one opening around a portion of the wearer's body, and placing the adhering portion around the wearer's such that the garment does not move.

Aspect 73: An apparatus comprising: a first surface comprising at least one of a textile, fabric, cloth, an insole, blended fabric, and other material; a second surface integral to the first surface; and wherein the second surface is configured to: contact the skin of a user with a friction, adhere to the skin, wherein the friction is sufficient to hold the apparatus in a fixed position.

Aspect 74: The apparatus of any preceding aspect, wherein the second surface comprises at least one of: leather, plastic leather, vinyl, faux leather, vegan leather, and synthetic leather.

Aspect 75: The apparatus of any preceding aspect, wherein the second surface comprises at least one of: organic synthetic leather, from flax, cotton fibers, laminated palm oil, laminated corn oil, laminated soybean oil, and laminated plant oils to create a leather-like material.

Aspect 76: The apparatus of any preceding aspect, wherein the second surface comprises at least one of: bi-cast leather, bonded leather, PVC faux leather fabric, and PU faux leather fabric.

Aspect 77: The apparatus of any preceding aspect, wherein the second surface comprises at least one of: genuine leather.

Aspect 78: The apparatus of any preceding aspect, wherein the second surface comprises at least one of: plastic, polyurethane, polyvinyl chloride (PVC), and embossed paper.

Aspect 79. An apparatus comprising a first substrate comprising at least one of a textile, fabric, cloth, an insole, blended fabric, and other material; a second substrate integral to the first substrate; wherein the second substrate is configured to: contact the skin of a user, adhere to the skin in a non-bruising manner that does not rupture or leave impressions on the skin, hold the apparatus in a fixed position; and wherein the second substrate comprises at least one of: bi-cast leather, bonded leather, PVC faux leather fabric, PU faux leather fabric, leather, plastic leather, vinyl, faux leather, pleather, vegan leather, and synthetic leather.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. An article configured to releasably adhere to a surface comprising:
an article including at least one adhering portion comprising a textile having an integral surface adhering substrate, said adhering portion configured to releasably adhere to the surface using the adhering substrate, the adhering portion having an interior surface and an exterior surface corresponding to the adhering substrate; wherein the at least one adhering portion is configured to releasably adhere to a surface of an object the article is placed on.

2. The article of claim 1, wherein the article is at least one of: an article of clothing, an article of eyewear, and article of footwear, or article of manufacture, household good, or combinations thereof.

3. The article of claim 2, wherein the textile comprises plastic, polyurethane, polyvinyl chloride (PVC), embossed paper, leather, plastic leather, vinyl, faux leather, vegan leather, and synthetic leather, or combinations thereof.

4. A garment configured to releasably adhere to a surface, the garment comprising:
a garment body; and
at least one garment adhering portion comprising textile having an integral skin adhering substrate, said garment adhering portion configured to releasably adhere to the surface using the adhering substrate, the garment adhering portion having an interior surface and an exterior surface corresponding to the adhering substrate, a first edge and a second edge;
wherein the garment adhering portion is configured to releasably adhere to a wearer's body surface and a garment body surface.

5. The garment of claim 4, wherein the adhering panel is comprised of a non-slip material configured to be releasably adhered against a portion of a wearer's body.

6. The garment of claim 5, wherein at least one adhering panel defines an outermost opening or edge of the garment body.

7. The garment of claim 6, wherein an adhering panel may comprise an outer panel and inner panel which may be integrated or comprise two-ply construction, or combinations thereof.

8. The garment of claim 7, further comprising at least one attachment means configured to attach one or more garment portions or adhering panels; wherein an attachment means is disposed on one more portions of an inner surface of at least one adhering panel.

9. The garment of claim 8, wherein at least one adhering panel comprises a plurality of attachment means configured to detachably connect to one or more adhering panels using one or more bands; and wherein the plurality of attachment means comprise a plurality of attachment positions configured to allow for adjustment of skin adhering positioning.

10. The garment of claim 9, wherein the attachment means comprises at least one of hook and loop fasteners, buttons, hooks, snaps, fasteners, or a combination thereof.

11. The garment of claim 10, further comprising a gripping area on the adhering substrate; and wherein the gripping area comprises all of the exterior surface of the adhering panel.

12. The garment of claim 11, wherein the garment is configured to remain in place without the use of adhesives or mechanical fasteners.

13. The garment of claim 12, wherein the adhering panel comprises a non-breathable, anti-slip material selected from polyurethane, polyvinyl chloride (PVC), thermoplastic elastomers (TPEs), high-friction rubber, vinyl, embossed paper, leather, plastic leather, vinyl, faux leather, vegan leather, and synthetic leather, or combinations thereof.

14. The garment of claim 13, wherein the garment body comprises at least one of latex, LYCRA, silicone, spandex, nylon, elastane, polyester, lace, silk and/or cotton, or a combination thereof

15. The garment of claim 14, wherein the garment body comprises at least one of a woven fabric, non-woven fabric, natural fabric, synthetic fabric, or combinations thereof.

16. A method for releasably adhering a garment to a skin of a wearer, the method comprising the steps of:
a) providing the garment of claim 13; and
b) using the adhering substrate of the adhering portion to releasably adhere the garment to the wearer's skin.

17. The method of claim 16, wherein the step of using comprises wearing the garment, securing at least one adhering panel against a portion of the wearer's body, pulling an opening of the garment up on the wearer, securing at least one opening around a portion of the wearer's body, and placing the adhering portion around the wearer's such that the garment does not move.

18. The method of claim 17, wherein the adhering portion is configured to: contact the skin of a user with a friction, adhere to the skin, and wherein the friction is sufficient to hold the garment in a fixed position.

19. The method of claim 17, wherein the adhering portion is configured to contact the skin of a user, adhere to the skin in a non-bruising manner that does not rupture or leave impressions on the skin, and hold the garment in a fixed position.

20. The method of claim 17, wherein the garment is a head covering, scarf, or belt.
